(19) United States
(12) Patent Application Publication
(10) Pub. No.: US 2007/0173293 A1
(43) Pub. Date: Jul. 26, 2007

(54) Mobile phone hand-free extension device

(76) Inventor: Bao O. Tran, San Jose, CA (US)

Correspondence Address: TRAN & ASSOCIATES, 6768 MEADOW VISTA CT., SAN JOSE, CA, 95135, US

(21) Appl. No.: 11/340,735

(22) Filed: Jan. 26, 2006

(51) Int. Cl. H04M 1/00

(52) U.S. Cl. 455/569.1

(57) ABSTRACT

A hand-free extension device to support a mobile phone capable of networking with a personal area network (PAN) includes a PAN wireless transceiver having a processor and a cellular audio signal output; and a sound source selecting switch coupled to the cellular audio signal and to a car stereo audio signal, the switch controlled by the processor to route the cellular or the car stereo audio signals to one or more car speakers.

### BACKGROUND OF THE INVENTION

The present invention relates generally to a mobile phone hand-free extension device.

The technology of mobile phones has made possible mobile voice communication for millions of people. Mobile phones are carried and used daily by hundreds of millions of people and become an ordinary household items worldwide. The mobile phone user quite often makes the phone call while driving an automobile and therefore creates a potential hazardous driving condition since the driver has to hold the mobile phone and drive at the same time.

A hand-free kit is an external accessory to the mobile phone and its purpose is to free the driver from distraction of holding and using the mobile phone. Several technologies have been pursued to enable the driver to use the mobile phone without holding the cellular phone.

U.S. Pat. No. 6,134,456 discloses a control switch box with cables linking the mobile phones and the vehicular stereo system. However, installating such kind of accessory is quite involved and requires wiring and routing inside the automobile body.

U.S. Pat. No. 5,867,794 discloses another method that uses an FM transmitter to send the audio signal from the mobile phone to the vehicular FM radio. In the disclosure, there is no need to physically connect the mobile phone and the vehicular audio system. However, the disadvantage of this approach is that the frequency of the FM transmitter has to be set to the same channel as the FM radio receiver that the driver is currently listening to whenever he wants to use the hand-free kit. The frequency of either the FM transmitter or the FM radio receiver has to be adjusted and it causes much inconvenience in application.

U.S. Pat. No. 6,928,308 discloses a mobile phone hand-free extension device having an FM radio transmitter with an active frequency searching circuitry to utilize a vehicular FM radio receiver for reproducing the audio signals from the mobile phone. The active frequency searching circuitry automatically detects which frequency band the vehicular FM radio receiver is currently using and set the RF frequency of the FM transmitter to the detected frequency. The FM transmitter relays the audio signals from the mobile phone by transmitting the audio signals through radio wave to the vehicular FM radio receiver to be reproduced by the speaker of the receiver. The system detects radio frequency of the FM radio receiver and to set the frequency of the FM transmitter automatically.

U.S. patent application Ser. No. 20050135297 discloses a Bluetooth terminal, relay, and system for determining a network configuration automatically and for transferring to an optimal waiting state. The Bluetooth terminal is provided with a profile functioning as a headset for communicating a terminal on the partner side via a voice gateway terminal, includes an input key for accepting an input operation including a transmitting operation, a receiving operation, and a call termination operation. A waiting state selecting member is provided for selecting a waiting state to be transferred upon call termination from a first waiting state in which an SCO link is disconnected and an ACL link is maintained, a second waiting state in which the SCO link and the ACL link are both disconnected. The waiting state selecting member selects the first waiting state after communication without input key operation being terminated, and selects the second waiting state after communication with input key operation being terminated.

### SUMMARY OF THE INVENTION

In a first aspect, a hand-free extension device to support a mobile phone capable of networking with a personal area network (PAN) includes a PAN wireless transceiver having a processor and a cellular audio signal output; and a sound source selecting switch coupled to the cellular audio signal and to a car stereo audio signal, the switch controlled by the processor to route the cellular or the car stereo audio signals to one or more car speakers.

Implementations of the first aspect may include one or more of the following. The PAN can be a Bluetooth network. The switch can be a multiplexer. A car mounted microphone is connected to the wireless transceiver to capture user speech during a telephone call. One or more wireless audio equipment can be wirelessly communicating with the PAN such that the one or more car speakers renders audio generated by the wireless audio equipment. The wireless audio equipment can be one of the following: MP3 files, .WAV files, MPEG files. The switch can mix the cellular and the car stereo audio signals to allow a user to listen to both audio signals. Alternatively, the switch can provide one of the cellular and the car stereo audio signals to the one or more speakers. An amplifier can amplify the cellular audio signals. The amplifier can also fade the cellular and the car stereo audio signals during transitions between audio signal transitions.

In a second aspect, a method to provide hand-free calling with a mobile phone capable of networking with a personal area network (PAN) includes receiving a car stereo audio signal; receiving a cellular audio signal using the PAN; and selecting and routing one of the cellular audio signal or the car stereo audio signal to one or more car speakers.

Implementations of the second aspect may include one or more of the following. The PAN comprises Bluetooth. The routing can be multiplexing the audio signals. The method can capture user speech during a telephone call with a car mounted microphone coupled to the wireless transceiver. The one or more car speakers can be supplied with audio signals generated by one or more wireless audio equipment coupled to the PAN. The wireless audio equipment stores one of: MP3 files, .WAV files, MPEG files. The method can mix the cellular and the car stereo audio signals to allow a user to listen to both audio signals. Alternatively, only one of the cellular and the car stereo audio signals can be presented at a time to the one or more speakers.

In a third aspect, a method to provide hands-free conversation for a cellular telephone call includes turning on a car stereo equipment if the car stereo equipment is initially off; receiving cell phone audio over a personal area network (PAN); routing cell phone audio to a car speaker during the cellular telephone call; and routing the car stereo equipment signal to the car speaker when the call ends.

Implementations of this aspect may include one or more of the following. The device can mute the speaker during transitions between cellular phone audio and car stereo audio to prevent an abrupt clicking sound. The device can also fade sound from car speaker during transitions between cellular phone audio and car stereo audio.

Advantages of the system may include one or more of the following. The system allows conventional car radios to work with modern cell phones such as Bluetooth capable cell phones. This is automatically done without needing to detect the radio frequency being tuned by a vehicular FM radio receiver and to relay the audio signal from a mobile phone to the vehicular FM radio receiver using a radio wave at the frequency detected.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a general schematic diagram showing the audio output extension for a mobile phone hands-free operation according to the present invention.

FIG. 2 shows in more detail an exemplary Bluetooth receiver used in FIG. 1.

FIG. 3 shows a second embodiment of a mobile phone hands-free apparatus.

FIG. 4 shows a flow chart for providing audio output extension for a mobile phone hand-free operation according to the present invention.

### DETAILED DESCRIPTION OF THE INVENTION

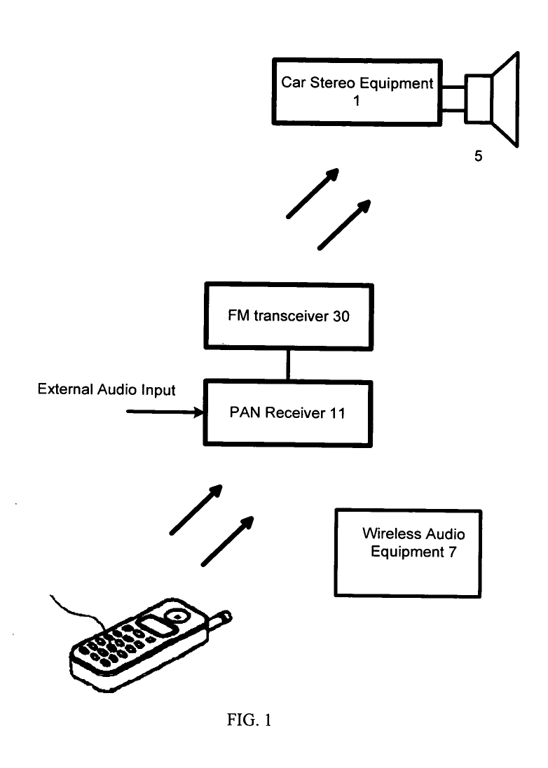

FIG. 1 is a general schematic diagram showing an audio output extension device 10 for a mobile phone hand-free operation according to the present invention. Referring to FIG. 1, the mobile phone hand-free extension device 10 includes a short-range receiver 11 that wirelessly communicates with a cellular telephone 2 and other wireless audio equipment 7 (such as Bluetooth equipped MP3 players, Bluetooth PDAs, or additional Bluetooth cell phones, for example) through a personal area network (PAN) such as Bluetooth. The short range receiver 11 can also receive external audio input from devices such as the iPod or Zen music player, MP3 player, GPS system or other suitable players.

In the embodiment of FIG. 1, the device 10 is directly connected or cabled/wired to the output of the car stereo equipment 1 that can receive various signals including AM signals, FM signals, satellite signals (Sirius or XM satellites for example), tape signals, and/or CD signals. The stereo equipment output is provided as an input to a sound source selecting switch or multiplexer 9 that receives the output of the car radio 1 as well as the output of the receiver 11 and can route either cell phone sound or the car radio sound to a car audio system 5 such as surround sound speakers. The receiver 11 includes a relay connected to the power input of the car stereo equipment to allow a processor to instruct the relay to turn on or off the car stereo equipment 1. This allows completely automatic operation of the stereo equipment 1 as opposed to requiring the user to first manually turn on the stereo equipment 1. The receiver 10 optionally includes an audio power amplifier that amplifies an output audio signal of the mobile-phone 2.

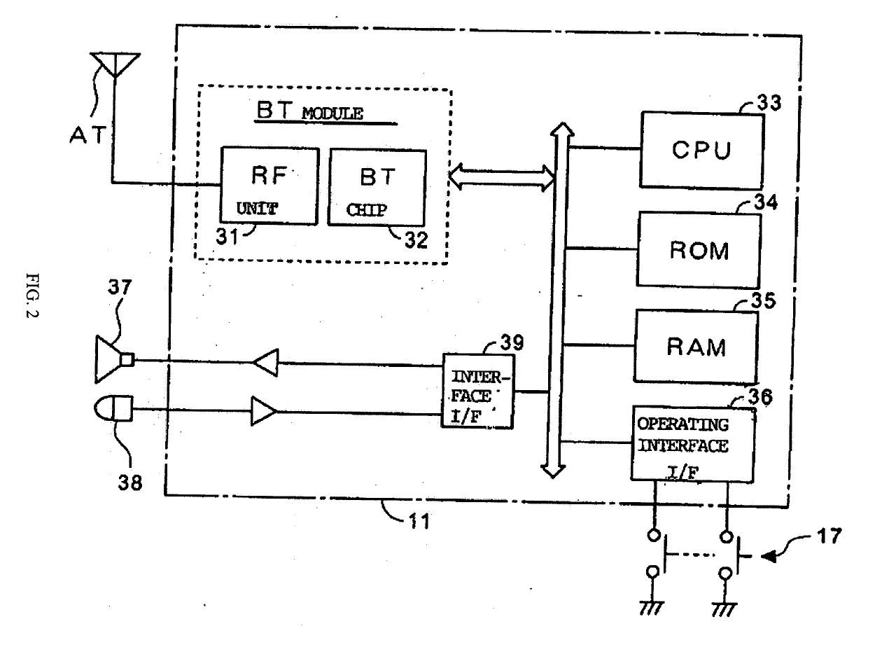

In one embodiment shown in FIG. 2, the receiver 11 is a Bluetooth (BT) compatible device. A CPU 33 executes various processes according to a program stored in a ROM 34. A RAM 25 provides a work area for storing data or the like temporarily when the CPU 33 executes various processes. An operating interface 36 is connected to the various input keys 17 (16). A BT module, the CPU 33, the ROM 34, the RAM 35 and the interface 36 are connected to each other via a common bus. The device 10 optionally includes a speaker 37, and a microphone 38, which are connected to the common bus via an I/O interface 39. The BT module mainly includes an RF unit 31 and a BT chip 32. The BT chip 32 executes a process for establishing inter-Piconet synchronization with respect to the terminal on the partner side, or coding/decoding process or the like of the transmitting and receiving signals. In other words, the respective BT modules digital-modulate carrier signals by the transmitting data upon transmission, and spread spectrum is effected to the modulated carrier signals by frequency hopping. Thereafter, the transmitting signal, after having amplified to a level of transmission output which is equal to or smaller than a prescribed value, is transmitted from an antenna AT to the wireless terminal on the partner side. Wireless signals from the wireless terminal on the partner side are received via the antenna AT, then inverse spread spectrum is effected, and then digital decoding is executed.

The receiver 11 can process AM/FM/CD stereo receiver. In addition to handling radio stations, the receiver 11 lets users listen to MP3 music while pairing with most Bluetooth mobile phones. The I/O interface 39 is connected to keys that allow the driver to make calls, take calls, and access a mobile address book hands-free via voice-recognition technology. The keypad controls both phone dialing and messaging functions, as well as radio station presets in the audio mode. The receiver optionally provides a display such as an LCD display that shows Caller ID, and the radio or music source is automatically muted as the phone audio is routed through the vehicle's speakers 5. The LCD display can also show text information pertaining to MP3 tracks, and there is a search menu for tracks and playlists. Address book and other personalized features from the mobile phone easily synchronize with the receiver's internal memory, allowing the driver to quickly access contacts and make calls hands-free.

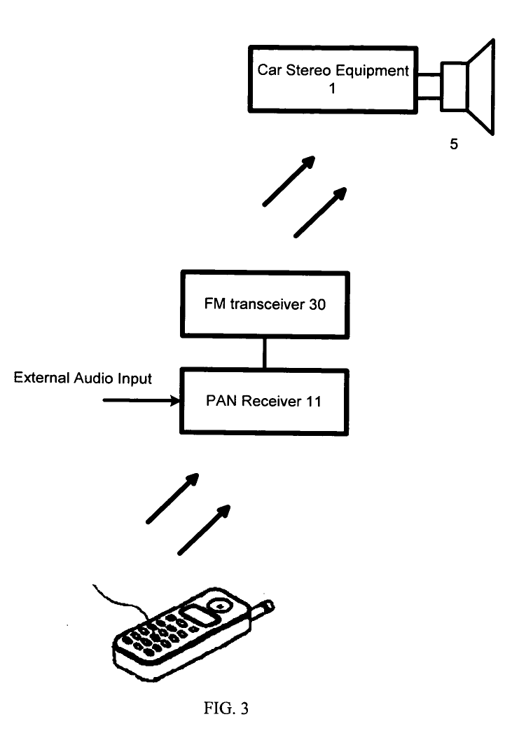

FIG. 3 shows an embodiment that does not require a direct wiring/cabling/connecting to the car stereo equipment 1. This embodiment is a Bluetooth aftermarket add-on equipment that converts existing car stereos into Bluetooth compatible radios or stereo equipment. In this embodiment, the PAN receiver 11 is connected to a AM or FM transceiver 30 that transmits to an existing car stereo equipment 1 over AM or FM frequencies. The stereo equipment 1 receives the transmissions and renders the transmission on speakers already wired to the pre-existing stereo equipment 1. In this manner, Bluetooth capability is provided without rewiring the car audio system.

In one embodiment, the FM transceiver 30 can be the FM transmitter disclosed in U.S. Pat. No. 6,928,308 having an active frequency searching circuitry to automatically detect which frequency band the vehicular FM radio receiver is currently using and set the RF frequency of the FM transmitter to the detected frequency. The FM transmitter relays the audio signals from the mobile phone by transmitting the audio signals through radio wave to the vehicular FM radio receiver to be reproduced by the speaker of the receiver. The system detects radio frequency of the FM radio receiver and to set the frequency of the FM transmitter automatically. In general, the active frequency-searching unit controls the radio frequency of a voltage-controlled oscillator (VCO) inside the FM transmitter and sends a signal with a particular pattern at the audio frequency to modulate the RF carrier of the FM transmitter. The signal sent with a particular pattern can be either a digital signal or an analog signal. The radio frequency of the FM transmitter is controlled in such a way that it starts from the lower band edge of the commercial FM band such as 88-108 MHz and increases repeatedly by a predetermined frequency step to the upper band edge. The preferred predetermined frequency step can be the allocated channel bandwidth of an FM station. At each frequency point, the FM transmitter will send out the modulated RF carrier. If the frequency of the FM transmitter matches that of the FM radio receiver 1, the signal with a particular pattern at the audio frequency will be demodulated, retrieved and broadcasted from the speaker 5 that is connected to the FM radio receiver. A microphone picks up the audio signal from the speaker and sends it to the active frequency search unit to determine if this audio signal is the same as the particular signal that the FM transmitter originally sent out. The frequency stepping process, the signal emitting process, and the signal comparing process are repeated over and over again until the original signal sent out by the frequency-searching unit is received by it again. When this condition is met, the RF frequency of the FM transmitter is locked on to that of the FM radio receiver. After the RF frequency of the FM transmitter is set to that of the FM radio receiver, a switch disconnects the audio signal generated by the frequency-searching unit and connects the audio signal picked up by a second microphone to the FM transmitter. The second microphone is placed close to the internal speaker of the mobile phone 2 to pick up the audio signal generated by the voice of the other party on the line. As a result, the audio signal is relayed to the FM radio receiver 1 and the voice is reproduced by the speaker 5.

In yet another embodiment, a digital-to-analog converter realizes the frequency-searching unit with a RF signal detector. When the RF signal detector detects the signal exchange between the mobile phone 2 and the base station, it sends a signal into one of the I/O port of the processor or microcontroller 33 (FIG. 2) to activate the frequency searching sequence. The frequency searching sequence works as follows: the microcontroller uses a plurality of I/O ports to send a parallel digital data to the DAC. The number of I/O ports used corresponds to the number of bits of the digital data. The DAC converts the digital data to a corresponding analog DC voltage value. The DC voltage is used to control the oscillating frequency of the voltage-controlled oscillator inside the FM transmitter and as a result the RF frequency of the FM transmitter is controlled by the microcontroller. The DAC is configured such that the minimum analog DC voltage converted from the digital data corresponds to the lower band edge of the commercial FM bands and the maximum analog DC voltage converted from the digital data corresponds to the upper band edge of the commercial FM bands. The microcontroller can increase or decrease the RF frequency of the FM transmitter by a minimum frequency step that is determined by the number of bits used for a digital data. For example, if 10 bits are used for a digital data, the step frequency will be (108-88) MHz divided by 210, i.e. 19.5 KHz. The microcontroller increases the RF frequency of the FM transmitter from the lower band edge to the upper band edge or in a reverse way decreases the frequency from upper band edge to the lower band edge repeatedly by a frequency step in a programmable way to cover the whole commercial FM frequency band. At each frequency point, the microcontroller sends a beacon signal at audio frequency with a particular pattern from one of its I/O ports to the FM transmitter through the switch. The pattern of the beacon signal is chosen to be different from any other possible audio signal, such as a voice signal or a noise signal from the automobile in the environment. The RF carrier modulated by the beacon signal is transmitted by the FM transmitter at the RF frequency set by the microcontroller. If the car FM radio receiver or stereo equipment 1 is working at the same RF frequency, the car RF radio receiver 1 will receive and demodulate the beacon signal, which is further broadcasted by the speaker 5. The microphone picks up the beacon signal and sends it to a signal comparator to determine if the received signal has the same pattern as the original beacon signal. If the signal pattern is matched, it represents a frequency locking condition, i.e. the FM transmitter 30 and the car FM radio receiver 1 are both working at the same RF frequency channel.

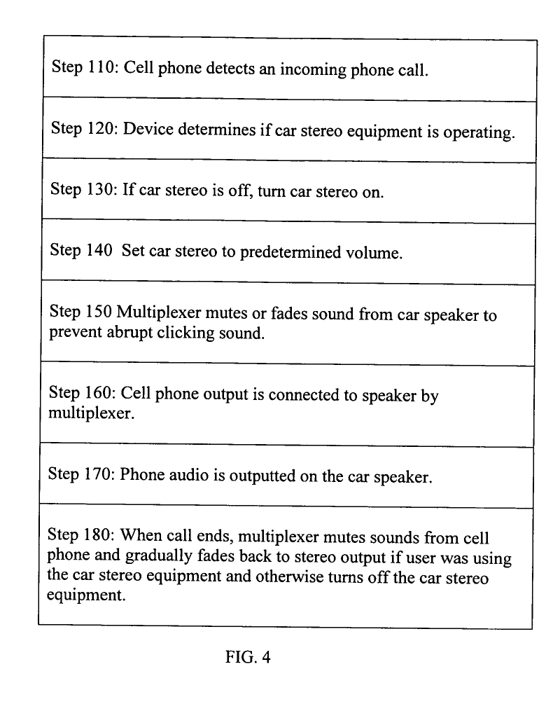

FIG. 4 shows a flow chart 100 for providing audio output extension for a mobile phone hand-free operation according to the present invention:

Step 110: Cell phone detects an incoming phone call.

Step 120: Device determines if car stereo equipment is operating.

Step 130: If car stereo is off, turn car stereo on.

Step 140 Set car stereo to predetermined volume.

Step 150 Multiplexer mutes or fades sound from car speaker to prevent abrupt clicking sound.

Step 160: Cell phone output is connected to speaker by multiplexer.

Step 170: Phone audio is outputted on the car speaker.

Step 180: When call ends, multiplexer mutes sounds from cell phone and gradually fades back to stereo output if user was using the car stereo equipment and otherwise turns off the car stereo equipment.

In one embodiment, the cell phone or another Bluetooth media player can transmit music to the device 10 to play music such as MP3 music or MPEG audio to the car stereo equipment over the Bluetooth piconet.

In yet another embodiment, the device 100 can be embedded in a phone and avoid the need to physically connect the mobile phone and the vehicular audio system. This is done by automatically detecting radio frequency of the FM radio receiver and to set the frequency of the FM transmitter automatically as taught in U.S. Pat. No. 6,928,308 which discloses a mobile phone hand-free extension device having an FM radio transmitter with an active frequency searching circuitry to utilize a vehicular FM radio receiver for reproducing the audio signals from the mobile phone, the content of which is incorporated by reference. In this embodiment, the Bluetooth transceiver in the cell phone can interact with another Bluetooth media player that can transmit music to the device 10 over the Bluetooth piconet to play music such as MP3 music or MPEG audio to the car stereo equipment using an FM transmitter embedded in the cell phone. This embodiment can send music from a Bluetooth equipped Apple iPod, for example, to the car FM receiver directly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hand-free extension device to support a mobile phone capable of networking with a personal area network (PAN) and communicating with a car stereo, comprising:
a PAN wireless transceiver having a processor and a cellular audio signal output; and
a sound source selecting switch coupled to the cellular audio signal and to a car stereo audio signal, the switch controlled by the processor to apply power to the car stereo and to route the cellular or the car stereo audio signals to one or more car speakers.

2. The device of claim 1, wherein the PAN comprises Bluetooth.

3. The device of claim 1, wherein the switch comprises a multiplexer.

4. The device of claim 1, comprising a car mounted microphone coupled to the wireless transceiver to capture user speech during a telephone call.

5. The device of claim 1, comprising one or more wireless audio equipment coupled to the PAN, wherein the one or more car speakers renders audio generated by the wireless audio equipment.

6. The device of claim 5, wherein the wireless audio equipment stores one of: MP3 files, .WAV files, MPEG files.

7. The device of claim 1, wherein the switch mixes the cellular and the car stereo audio signals to allow a user to listen to both audio signals.

8. The device of claim 1, wherein the switch provides one of the cellular and the car stereo audio signals to the one or more speakers.

9. The device of claim 1, comprising an amplifier coupled to the cellular audio signal.

10. The device of claim 9, wherein the amplifier fades the cellular and the car stereo audio signals during transitions between audio signal transitions.

11. A method to provide hand-free calling with a mobile phone capable of networking with a personal area network (PAN) and an FM radio receiver, comprising:
receiving a car stereo audio signal;
receiving a cellular audio signal using the PAN; and
determine the channel frequency setting of the FM radio receiver, including:
generating an electrical signal with a particular pattern;
modulating an FM carrier at a frequency within a commercial FM band with said electrical signal;
transmitting said modulated FM carrier to said FM radio receiver;
receiving an audio signal reproduced by said FM radio receiver and detecting said particular pattern;
determining if the frequency of said FM carrier matches that of said FM radio frequency receiver by the successful detection of said particular pattern; and
changing the frequency of said FM carrier and repeating above steps until the frequency of said FM carrier matches that of said FM radio receiver;
routing one of the cellular audio signal through the FM radio receiver to one or more car speakers during a telephone call.

12. The method of claim 11, wherein the PAN comprises Bluetooth.

13. The method of claim 11, wherein the selecting comprises multiplexing the audio signals.

14. The method of claim 11, comprising capturing user speech during a telephone call with a car mounted microphone.

15. The method of claim 11, comprising driving one or more car speakers with audio signals generated by one or more wireless audio equipment coupled to the PAN.

16. The method of claim 15, wherein the wireless audio equipment stores one of: MP3 files, .WAV files, MPEG files.

17. The method of claim 11, comprising mixing the cellular and the car stereo audio signals to allow a user to listen to both audio signals.

18. The method of claim 11, comprising providing only one of the cellular and the car stereo audio signals to the one or more speakers.

19. A method to provide hands-free conversation for a cellular telephone call, comprising:
turning on a car stereo equipment if the car stereo equipment is initially off;
receiving cell phone audio over a personal area network (PAN);
routing cell phone audio to a car speaker during the cellular telephone call; and
routing the car stereo equipment signal to the car speaker when the call ends.

20. The method of claim 18, comprising muting the speaker during transitions between cellular phone audio and car stereo audio to prevent an abrupt clicking sound.
